(19) United States
(12) Patent Application Publication
(10) Pub. No.: US 2016/0260034 A1
(43) Pub. Date: Sep. 8, 2016

(54) PROCESS RE-ENGINEERING ANALYSIS

(71) Applicant: Novitex Enterprise Solutions, Inc., Stamford, CT (US)

(72) Inventors: Ken Bechard, Royal Oak, MI (US); David Mullaney, Hobart, IN (US)

(21) Appl. No.: 14/637,350

(22) Filed: Mar. 3, 2015

(51) Int. Cl. G06Q 10/06

(52) U.S. Cl. CPC G06Q 10/0633

(57) ABSTRACT

Embodiments of the invention provide a method, system and computer program product for process re-engineering analysis. The method includes generating a graphical display in an analysis tool and inputting in the display a set of steps of an existing business process specifying in the display a set of key criteria against which the set of steps are evaluated. A set of steps of a new business process intended to replace the existing business process are additionally input into the display and the new steps are scored in the display in connection with the key criteria in terms of improving the criteria, worsening the criteria, or no change. Finally, a sum of the scores is computed to produce an aggregate score for the new steps and indicating in the display a bias to the new steps in response to a determination that the aggregate score is better than the existing process.

### BACKGROUND OF THE INVENTION

1. Field of the Invention

The present invention relates to process engineering and more particularly to business process re-engineering analysis.

2. Description of the Related Art

Business process re-engineering is the analysis and redesign of workflows within and between enterprises in order to optimize end-to-end processes and to automate non-value-added tasks. In business process re-engineering, the re-thinking of all business processes, job definitions, management systems, organizational structure, work flow, and underlying assumptions and beliefs is required so as to effect a radical rather than an incremental redesign of processes. In consequence, dramatic improvements are achieved in critical areas of the enterprise, such as cost, quality, service, and response time through the in-depth use of information technology.

Of note, business process re-engineering aims to make the structure of an organization serve the flow of products and services of the organization and result in the production of a leaner and fitter organization. A typical business process re-engineering project consists of first identifying the relevant business processes and subsequently, reviewing, updating and analyzing the business processes as they exist contemporaneously. Thereafter, one or more new business processes are designed and the new business processes are tested and implemented.

Importantly, business process re-engineering projects often involve modern methodologies, notations and technologies, including software modeling tools, that are designed to facilitate and maximize expected results, thereby enabling process maintenance and adjustment, while the organization and its business environment change over time. Business process re-engineering projects also address horizontal, department level process subsets, and vertical, end-to-end process subsets of a subject organization, according to the business goals of the subject organization. Furthermore, business process re-engineering projects can extend to information technology implementations as well as the definition and monitoring of key performance indicators, known as “KPIs”.

### BRIEF SUMMARY OF THE INVENTION

Embodiments of the present invention address deficiencies of the art in respect to business process re-engineering and provide a novel and non-obvious method, system and computer program product for process re-engineering analysis. In an embodiment of the invention, a method for process re-engineering analysis includes generating a graphical display in an analysis tool executing in memory of a host computer system. The method also includes inputting in the graphical display a set of steps of an existing business process specifying in the graphical display a set of key criteria against which the set of steps are evaluated. The method yet further includes additionally inputting into the graphical display a set of steps of a new business process intended to replace the existing business process and scoring the new steps in the graphical display in connection with the key criteria in terms of improving the criteria, worsening the criteria, or no change. Finally, the method includes computing by a processor of the host computer system a sum of the scores to produce an aggregate score for the new steps and indicating in the graphical display a bias to the new steps in response to a determination that the aggregate score is better than the existing process.

In aspect of the embodiment, the graphical display incorporates a Pugh matrix. In another aspect of the embodiment, the method also includes specifying in a functional deployment map of the analysis too, a set of possible points of failure and grading within the functional deployment map the points of failure in terms of severity, likelihood of occurrence and detectability. Subsequently, each of the possible points of failure are sorted by a processor of the host computing system within the functional deployment map to identify a most severe, likely to occur point of failure and the points of failure of a revised form of the new business process are re-graded within the functional deployment map. Finally, each of the possible points of failure are sorted by the processor of the host computing system within the functional deployment map to identify a new most severe, likely to occur point of failure.

In another embodiment of the invention, a data processing system is configured for process re-engineering analysis. The system includes a host computing system that includes one or more computers each with memory and at least one processor and an analysis tool executing in the memory of the host computing system. The system yet further includes a process re-engineering module coupled to the analysis tool. The module includes program code executing in the memory of the computer that is enabled to generate a graphical display in the analysis tool, to receive input into the graphical display both of a set of steps of an existing business process and also of a set of key criteria against which the set of steps are evaluated, to additionally receive input into the graphical display of a set of steps of a new business process intended to replace the existing business process, to receive a score for each of the new steps in the graphical display in connection with the key criteria in terms of improving the criteria, worsening the criteria, or no change, to compute a sum of the scores to produce an aggregate score for the new steps, and to indicate in the graphical display a bias to the new steps in response to a determination that the aggregate score is better than the existing process.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for process re-engineering analysis;

FIG. 2 is a schematic illustration of a data processing system configured for process re-engineering analysis; and,

FIG. 3 is a flow chart illustrating a process for process re-engineering analysis.

### DETAILED DESCRIPTION OF THE INVENTION

Embodiments of the invention provide for process re-engineering analysis. In accordance with an embodiment of the invention, an analysis tool can present a graphical display incorporating a Pugh matrix in which a set of steps of an existing business process are input along with a set of key criteria against which the set of steps are to be evaluated during business process re-engineering of organization. Additionally set of steps of a new business process intended to replace the existing business process are input into the graphical display and scored in connection with the key criteria in terms of improving the criteria, worsening the criteria, or no change. Finally, the scores are summed in the graphical display to produce an aggregate score for the new steps. Consequently, a bias to the new steps can be indicated in the graphical display in response to a determination that the aggregate score is better than the existing process.

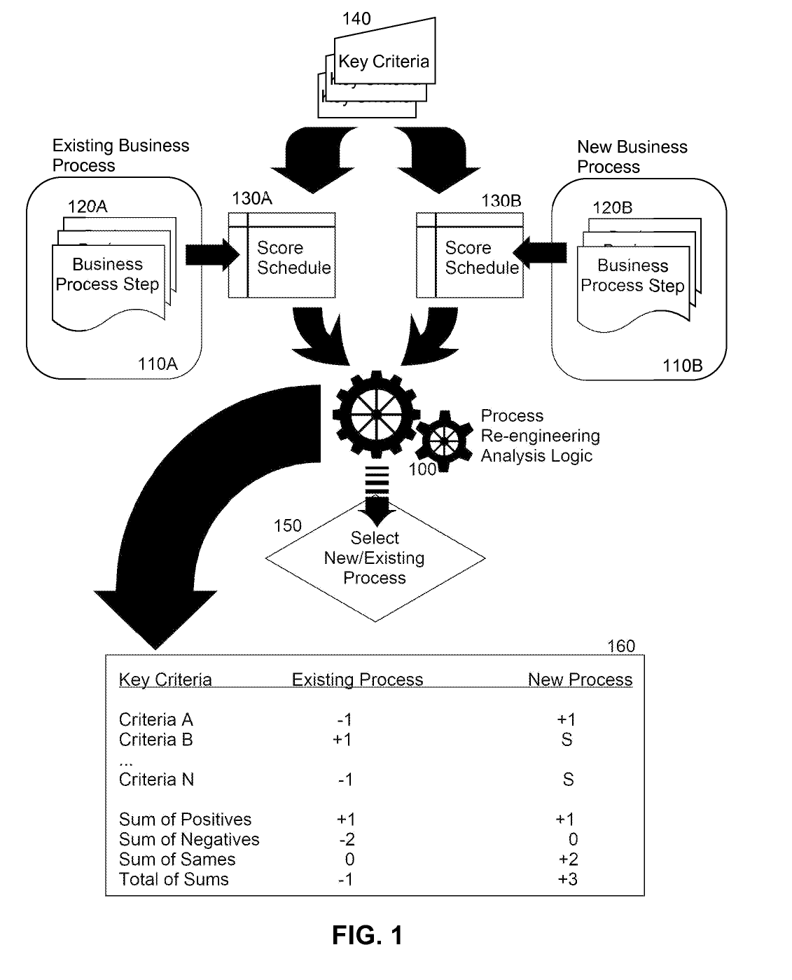

In further illustration, FIG. 1 pictorially shows a process for process re-engineering analysis. As shown in FIG. 1, an existing business process 110A of one or more process steps 120A can be defined in a display 160 of an analysis tool. Also, a new business process 110 of one or more process steps 120B can be defined in the display 160 of the analysis tool. Finally, one or more key criteria 140 can be specified in the display 160. The key criteria 140 can include evaluative criteria resulting from the implementation of a particular step or steps of a business process by which the impact of the step or steps can be measured in terms of a favorable impact, a negative impact or a neutral impact.

Thereafter, a score schedule 130A, 130B for both business processes 110A, 110B can be specified in the display 160 in that for each of the key criteria 140, an impact of one or more of the steps 120A, 120B can be specified in terms of a favorable impact, a negative impact or a neutral impact. Once the score schedule 130A, 130B has been specified, process re-engineering analysis logic 100 can produce a selection 150 of a better performing one of the business processes 110A, 110B based upon a sum of the favorable impacts, a sum of the negative impacts, a sum of neutral impacts, a sum of all impacts, a sum of weighted favorable impacts, weighted negative impacts, or a sum of all weighted impacts, or any combination thereof.

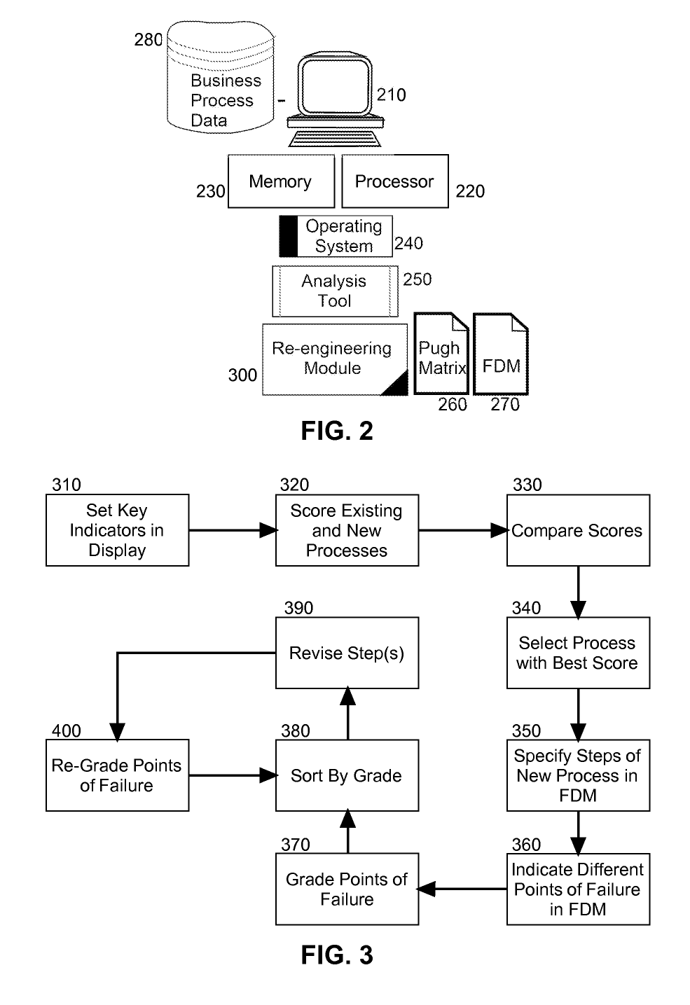

The process described in connection with FIG. 1 can be implemented in a data processing system. In yet further illustration, FIG. 2 schematically shows a data processing system configured for process re-engineering analysis. The system includes a host computing system 210 that includes one or more computers each with at least one processor 220 and memory 230. The host computing system 210 can support the execution of an operating system 240 that supports the operation of an analysis tool 250. The analysis tool 250 is a computer program or set of computer programs configured upon execution in the memory 230 of the host computing system 210 to specify process steps of one or more business processes according to business process data stored in a data store 280 of the host computing system 210, to quantify aspects of each of the steps and to visualize an impact of implementing each of the one or more business processes.

Of note, a business process re-engineering analysis module 300 can be coupled to the analysis tool 250. The module 300 includes program code that when executed in the memory of the host computing system 210, is enabled to generate a display in the host computing system 210 of a Pugh matrix 260 into which both an existing business process or one or more process steps, and a proposed, new business process of one or more steps is specified. The program code of the module 300 additionally is enabled upon execution in the memory of the host computing system 210 to establish within the Pugh matrix 260, one or more key criteria. Yet further, the program code of the module 300 is enabled to upon execution in the memory of the host computing system 210 to score within the Pugh matrix 260 one or more of the steps of the existing and new business processes with respect to each of the key criteria, and to sum the scores so as to compare the existing and new business processes and select a best performing one of the business processes.

Optionally, the program code of the module 300 is additionally enabled to render in a display of the host computing system 210, a functional deployment map 270 into which one or more likely points of failure are identified for the process steps of the new business process. Each identified likely point of failure in the functional deployment map 270 further is graded by the program code of the module 300 in terms of severity, likelihood of occurrence and detectability, and the program code thereafter sorts within the functional deployment map 270 each of the possible points of failure to identify a most severe, likely to occur point of failure. Subsequently, in response to a revision of one or more of the process steps of the new business process, the steps are re-graded in the functional deployment map 270 by the program code of the module 300 and, again, the possible points of failure are re-sorted so as to identify a next most severe point of failure giving rise to a need to revise one or more of the business process steps. This procedure can continue until no further severe likely points of failure remain.

In even yet further illustration of the operation of the business process re-engineering analysis module 300, FIG. 3 is a flow chart illustrating a process for process re-engineering analysis. Beginning in block 310, one or more key criteria are defined in a display of the analysis tool, for instance a Pugh matrix. In block 320, one or more steps of both a new business process and an existing business process are scored relative to each of the key criteria, for instance in terms of improve, degrade or stay the same. In block 330, a summation of the scores for each of the business processes can be computed, for instance a sum of the positives, a sum of the negatives, a sum of the sames, a weighted sum of any of the forgoing, a sum of the sums or a sum of the weighted sums, and the computed sums are compared to one another in order to identify a best performing one of the processes in block 340.

In block 350, one or more of the steps of the new business process are specified in a six-sigma functional deployment map. In block 360, one or more points of failure in respect to one or more of the steps can be indicated in the functional deployment map and in block 370, each of the points of failure can be graded in accordance with severity, likelihood of occurrence and detectability. Subsequently, in block 380 the points of failure are sorted in accordance with severity and in block 390 a revision to a corresponding one of the steps of the new business process can be revised. In response to the revision, in block 400 the points of failure can be re-graded and the procedure can repeat through block 380.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for process re-engineering analysis comprising:
generating a graphical display in an analysis tool executing in memory of a host computer system;
inputting in the graphical display a set of steps of an existing business process and specifying in the graphical display a set of key criteria against which the set of steps are evaluated;
additionally inputting into the graphical display a set of steps of a new business process intended to replace the existing business process;
scoring the new steps in the graphical display in connection with the key criteria in terms of improving the criteria, worsening the criteria, or no change;
computing by a processor of the host computer system a sum of the scores to produce an aggregate score for the new steps; and,
indicating in the graphical display a bias to the new steps in response to a determination that the aggregate score is better than the existing process.

2. The method of claim 1, wherein the graphical display incorporates a Pugh matrix.

3. The method of claim 1, further comprising:
specifying in a functional deployment map of the analysis too, a set of possible points of failure;
grading within the functional deployment map the points of failure in terms of severity, likelihood of occurrence and detectability;
sorting by a processor of the host computing system within the functional deployment map each of the possible points of failure to identify a most severe, likely to occur point of failure;
re-grading the points of failure of a revised form of the new business process within the functional deployment map; and,
re-sorting by the processor of the host computing system within the functional deployment map each of the possible points of failure to identify a new most severe, likely to occur point of failure.

4. A data processing system configured for process re-engineering analysis, the system comprising:
a host computing system that includes one or more computers each with memory and at least one processor;
an analysis tool executing in the memory of the host computing system; and,
a process re-engineering module coupled to the analysis tool, the module comprising program code executing in the memory of the computer, the program code being enabled to generate a graphical display in the analysis tool, to receive input into the graphical display both of a set of steps of an existing business process and also of a set of key criteria against which the set of steps are evaluated, to additionally receive input into the graphical display of a set of steps of a new business process intended to replace the existing business process, to receive a score for each of the new steps in the graphical display in connection with the key criteria in terms of improving the criteria, worsening the criteria, or no change, to compute a sum of the scores to produce an aggregate score for the new steps, and to indicate in the graphical display a bias to the new steps in response to a determination that the aggregate score is better than the existing process.

5. The system of claim 4, wherein the graphical display incorporates a Pugh matrix.

6. The system of claim 4, wherein the program code is further enabled to display a functional deployment map in the graphical display, to specify in the functional deployment map a set of possible points of failure, to grade within the functional deployment map the points of failure in terms of severity, likelihood of occurrence and detectability, to sort within the functional deployment map each of the possible points of failure to identify a most severe, likely to occur point of failure, to re-grade the points of failure of a revised form of the new business process within the functional deployment map, and to re-sort within the functional deployment map each of the possible points of failure to identify a new most severe, likely to occur point of failure.

7. A computer program product for process re-engineering analysis, the computer program product comprising a computer readable storage medium having program instructions embodied therewith, the program instructions executable by a device to cause the device to perform a method comprising:
generating a graphical display in an analysis tool;
inputting in the graphical display a set of steps of an existing business process and specifying in the graphical display a set of key criteria against which the set of steps are evaluated;
additionally inputting into the graphical display a set of steps of a new business process intended to replace the existing business process;
scoring the new steps in the graphical display in connection with the key criteria in terms of improving the criteria, worsening the criteria, or no change;
computing a sum of the scores to produce an aggregate score for the new steps; and,
indicating in the graphical display a bias to the new steps in response to a determination that the aggregate score is better than the existing process.

8. The computer program product of claim 7, wherein the graphical display incorporates a Pugh matrix.

9. The computer program product of claim 7, wherein the method further comprises:
specifying in a functional deployment map of the analysis too, a set of possible points of failure;
grading within the functional deployment map the points of failure in terms of severity, likelihood of occurrence and detectability;
sorting by a processor of the host computing system within the functional deployment map each of the possible points of failure to identify a most severe, likely to occur point of failure;
re-grading the points of failure of a revised form of the new business process within the functional deployment map; and,
re-sorting by the processor of the host computing system within the functional deployment map each of the possible points of failure to identify a new most severe, likely to occur point of failure.
